(19) United States
(12) Patent Application Publication
(10) Pub. No.: US 2003/0147574 A1
(43) Pub. Date: Aug. 7, 2003

(54) Travelling-wave electroabsorption modulator

(76) Inventors: Yee Loy Lam, Singapore (SG); Hiroshi Nakamura, Singapore (SG); Yuen Chuen Chan, Singapore (SG)

Correspondence Address: Buckley, Maschoff, Talwalkar, & Allison LLC, Five Elm Street, New Canaan, CT, 06840, US

(21) Appl. No.: 10/308,452

(22) Filed: Dec. 3, 2002

(30) Foreign Application Priority Data
Dec. 3, 2001 (GB) 0128903.2

(51) Int. Cl. G02F 1/01

(52) U.S. Cl. 385/1; 385/40

(57) ABSTRACT

According to the present invention, a travelling-wave electroabsorption modulator (TW-EAM) comprises: an optical waveguide with a plurality of adjacent regions electrically isolated from each other, the regions being characterized alternately by the properties of electroabsorption (EA) and optical transparency over the same range of optical wavelengths, and a microwave transmission line located above the optical waveguide, such that sections of the transmission line located above EA regions in the optical waveguide are in electrical contact with said EA regions, whereas sections of the transmission line located above transparent regions in the optical waveguide are electrically isolated from said transparent regions.

In the absence of a microwave signal, the EA regions are substantially transparent to light in the optical waveguide. When a microwave signal is applied to the EA regions, they become substantially absorbing at the wavelength of the light in the optical waveguide. Thus, by applying a fast time-varying microwave signal to the transmission line, the absorption of light in the waveguide can be modulated temporally, thereby encoding information onto the light beam.

### FIELD OF THE INVENTION

The present invention relates to a high speed modulating device for use in optical communication systems, and in particular a travelling-wave electroabsorption modulator.

### BACKGROUND TO THE INVENTION

The demand for optical communication systems with increased speed and broader bandwidth continues to grow. In order to meet this need, a commensurate increase in performance is being demanded of the individual components forming the optical network. Amongst these, a key component is the optical modulator which is used to encode information, both digital and analogue, onto an optical carrier wave.

Of the many approaches to realizing a high speed optical modulator, the electroabsorption modulator (EAM) has proved to be a popular choice and has been utilized for 10 Gb/s optical fibre based communication systems. In order to be compatible with fibre systems, the EAM usually comprises a waveguide section for optical confinement. The modulator may be fabricated as a stand alone device or can be integrated with a laser source in a single module, as has been done with certain types of distributed feedback (DFD) laser. Electroabsorption modulators have also been used as detectors and as multiplexers and demultiplexers in optical time division multiplexing (OTDM) systems.

The EAM operates via an electric field induced change in the absorption spectrum. A number of very fast physical mechanisms may be involved in this spectral shift, including the linear and quadratic Stark effect. In order to enhance the performance of such devices, multiple quantum well (MQW) structures have been included, thereby taking advantage of the quantum-confined Stark (QCS) effect. The form of a typical electroabsorption spectrum and its non-linear dependence means that a small applied electric field can induce a large change in absorption at a particular wavelength A reverse bias voltage applied to a MQW based EAM leads to a shift of the bandgap to longer wavelengths, permitting a device extinction ratio on the order of 20 dm for an applied signal of a few volts.

Although the underlying mechanism may be very fast, the modulation bandwidth of the conventional lumped-element EAM is limited by its inherent capacitance (C), which together with device resistance (R), limits the speed of response (τ=RC) to an electrical driving signal. Common approaches to alleviating this problem include the use of smaller shunt resistance, and a reduction in device capacitance by using shorter EAM waveguides. However, these approaches tend to compromise modulation efficiency and extinction ratio. One of the more successful examples of this type of approach uses a short MQW based EAM with integrated transparent input and output waveguides, fabricated on an InP:Fe substrate to reduce the stray capacitance.

In order to increase modulation bandwidth up to and beyond the 40 GHz required for next generation systems the travelling-wave EAM (TW-EAM) has been proposed and experimentally investigated. In a TW-EAM an electrode structure is employed that allows the driving microwave signal to propagate alongside the optical signal confined within the EAM waveguide. This transmission line allows good overlap of the modulation field with the EA region, permitting high speed operation with good modulation characteristics. The major challenge associated with the TW-EAM is obtaining velocity matching of the optical and microwave signals over a broad bandwidth, whilst limiting signal attenuation, particularly at the highest frequencies. One approach to the problem of velocity matching has been to use a TW-EAM having several discrete EAM regions. In this way a transmission line can be fabricated, overlapping these regions, whereby the microwave signal follows a longer path than the optical signal, thus enabling velocity matching.

Ideally, for efficient high frequency operation, the characteristic impedance of the transmission line should be matched to the input and output impedance of devices connected to the line, including the driving circuitry. Otherwise reflections will occur at locations where there is an impedance discontinuity, leading to a loss of signal strength and possible distortion of the modulated optical signal. The characteristic impedance of the EA region in a TW-EAM is typically in the range 15-30 Ω. However, the impedance of microwave circuits and transmission lines is usually 50 Ω. Thus far it has proved to be very difficult to achieve a TW-EAM with a characteristic impedance as high as 50 Ω.

### SUMMARY OF THE INVENTION

According to the present invention, a travelling-wave electroabsorption modulator (TW-EAM) comprises an optical waveguide with a plurality of adjacent regions electrically isolated from each other, the regions being characterized alternately by the properties of electroabsorption (EA) and optical transparency over the same range of optical wavelengths, and a microwave transmission line located above the optical waveguide, such that sections of the transmission line located above EA regions in the optical waveguide are in electrical contact with said EA regions, whereas sections of the transmission line located above transparent regions in the optical waveguide are electrically isolated from said transparent regions.

In the absence of a microwave signal, the EA regions are substantially transparent to light in the optical waveguide. When a microwave signal is applied to the EA regions, they become substantially absorbing at the wavelength of the light in the optical waveguide. Thus, by applying a fast time-varying microwave signal to the transmission line, the absorption of light in the waveguide can be modulated temporally, thereby encoding information onto the light beam.

As the transparent regions of the optical waveguide are electrically isolated from the microwave transmission line, they do not contribute their intrinsic capacitance to the line provided the transparent regions are also electrically isolated from the EA regions of the optical waveguide. This can be achieved by etching the waveguide at the interface of the two types of section, although some losses are introduced. Alternatively, isolation can be achieved by ion implantation using an n-type dopant or a deep level dopant. Of course, both methods of isolation may be employed simultaneously.

With this isolation in place, if the length of the waveguide is increased by using longer transparent sections, the length of the corresponding transmission line can also be increased to introduce further series inductance without increasing the intrinsic capacitance. In this way, the total characteristic impedance of the transmission line can be designed to have a range of values, including 50 Ω and above. Furthermore, the increased transmission line length between EA regions, together with the number and length of the EA regions, can be tailored to achieve effective velocity matching of the optical and microwave signals, whilst maintaining the same total EA length as would be used in a conventional TW-EAM comprising a single continuous EA region.

Preferably, the total length and composition of the waveguide is such that the total characteristic impedance of the associated microwave transmission line is rendered substantially 50 Ω, although other values are possible.

Preferably, the total length of the EA regions of the waveguide is substantially equivalent to that which would be used in a lumped EAM. In this way, the same level of attenuation can be achieved, leading to a high extinction ratio for the device.

The transparent regions of the waveguide may be isolated from the transmission line by means of air bridges or by raised regions of electrically insulating material. Thus, when viewed from the side the transmission line will appear corrugated, as the transmission line material, typically a metal, follows an undulating path over the raised insulating regions and down to contact the EA regions of the waveguide. By varying the dimensions of the raised insulating regions, the length of the transmission line can be varied independently of the length of the optical waveguide.

Preferably, the transparent regions of the waveguide are electrically isolated from the transmission line by means of raised regions of electrically insulating material located on top of the transparent regions of the waveguide.

The time taken by light to traverse the length of the optical waveguide will be determined by the physical length of the waveguide and also by the local refractive index of the material forming the waveguide. Similarly, the time taken by a microwave signal to traverse the length of the transmission line will be determined by the physical length of the transmission line and also by the local impedance of the transmission line. Thus, there are several parameters that may be optimized to achieve velocity matching of the optical and microwave signals.

Preferably, the length and composition of the transmission line is such that the microwave and optical signals are substantially velocity matched. In this way, optimal temporal overlap of the optical and microwave signals may be achieved at the locations of the EA regions in the waveguide.

There are a range of materials and mechanisms available to realize the phenomenon of electroabsorption within regions of the optical waveguide.

Preferably, the waveguide comprises a multiple quantum well (MQW) structure.

Preferably, the MQW structure is optimized to be electroabsorbing in the EA regions of the waveguide over the desired range of operational optical wavelengths.

The transparent regions of the waveguide must be substantially transparent to light over the desired range of operational optical wavelengths. This may be achieved by ensuring the waveguide material exhibits a large bandgap in the regions that are to be transparent. Appropriate tailoring of this bandgap may be achieved by selective epitaxial growth or by use of a quantum well Intermixing (QWI) process.

Preferably, both the input and output regions of the optical waveguide are optically transparent.

The optical waveguide will typically be formed on top of a semiconductor substrate. Preferably the substrate comprises an indium phosphide (InP) based material.

The present invention thus provides a TW-EAM for high-speed, broad-band modulation of optical signals with accurate velocity matching of the microwave and optical signals. The characteristic impedance of the accompanying microwave transmission line can be designed to exhibit a range of values, including 50 Ω, for accurate input or output impedance matching to other standard microwave devices, to avoid reflections.

Furthermore, the TW-EAM may be fabricated on a suitable substrate, such as InP, for integration with other optical devices, including semiconductor diode and laser diode sources.

According to another aspect of the present invention, an optical device for optical time division multiplexing or demultiplexing comprises a TW-EAM in accordance with the first aspect of the present invention.

### BRIEF DESCRIPTION OF THE DRAWINGS

Examples of the present invention will now be described in detail with reference to the accompanying drawings, in which;

FIGS. 1A and 1B show a top view and side view, respectively, of a distributed TW-EAM in accordance with the present invention; and,

FIGS. 2A and 2B show the equivalent lumped circuit model of the microwave transmission line for a prior art TW-EAM and the TW-EAM of FIGS. 1A and 1B, respectively.

### DETAILED DESCRIPTION

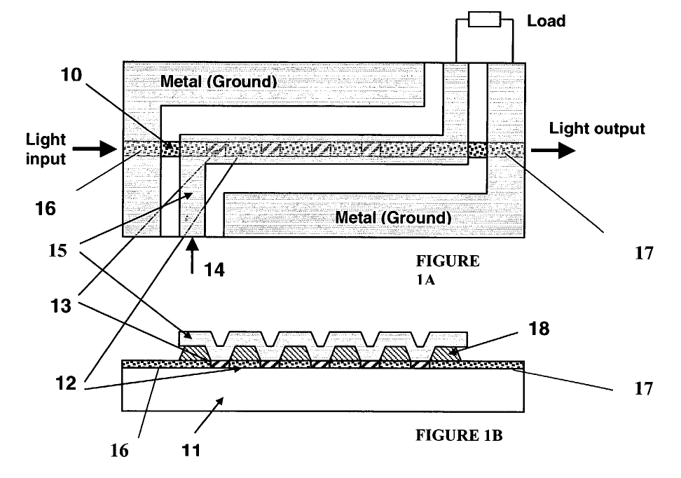

The present invention provides an apparatus for modulating optical signals by means of an optical waveguide with a distributed electroabsorbtion (EA) region, as shown in FIGS. 1A and 1B. The optical waveguide 10 is located on a semiconductor substrate 11 and comprises an InGaAs MQW structure with regions 12 of high optical transparency alternating with EA regions 13, which can be activated by a microwave signal 14 applied to a metallic transmission line 15 located above the waveguide.

Light enters the optical waveguide 10 via a transparent region at an optical input 16 and, in the absence of an applied microwave signal, propagates substantially unattenuated through the whole length of the waveguide 10, emerging via another transparent region at an optical output 17. When a microwave signal 14 is applied to the device it propagates along the transmission line 15 and, when in electrical contact with an EA region 13, the associated electric field causes the band edge of the MQWs to shift to longer wavelengths via the quantum-confined Stark effect. The PA regions 13 then strongly absorb light passing through them until such time as the applied microwave electric field is reduced in strength. Thus by applying a time-varying microwave signal to the TW-EAM, information encoded thereon can be transferred to the optical signal. The high extinction ratio that can be achieved with this device makes it particularly suited to the encoding of digital signals.

The combined length of the EA regions 13 is approximately equivalent to that used in a conventional lumped EAM, allowing an equally high optical attenuation to be achieved. The transparent regions 12 of the waveguide 10 are electrically isolated from the adjacent ERA regions 13 by etching and/or ion implantation. The transparent regions 12 of the waveguide 10 are electrically isolated from the transmission line 15 by bars of an electrically insulating material 18, as shown in the cross section of FIG. 1B. The transmission line 15 therefore follows an undulating path over the length of the waveguide 10. In this way, further series inductance can be added to the transmission line 15 without adding to the capacitance. Both stray and intrinsic capacitance is present, the intrinsic capacitance being associated with a p-i-n junction within the vertical structure of the waveguide.

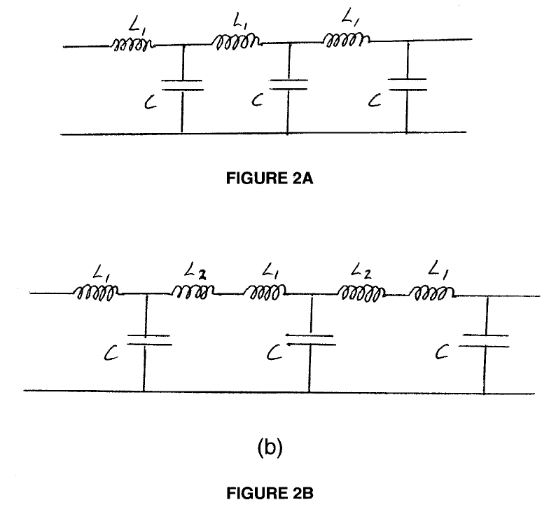

FIGS. 2A and 2B show an equivalent lumped circuit model of the microwave transmission line for a prior art TW-EAM and the TW-EAM of FIG. 1, respectively. Each additional section of transmission line insulated from a waveguide transparent region adds series inductance L₂ to the inductance L, inherent to the transmission line, without adding to the capacitance C. In this way, the characteristic impedance of the line, given by the expression Z=\sqrt{(L₁+L₂)/C}, can be increased to the desired value.

An example of this is illustrated by the comparison shown in Table 1. The new TW-EAM, in accordance with the present invention, has a total waveguide length five times that of the conventional TW-EAM, whilst maintaining the same total EA length. By comparing the second and third columns of Table 1, it can be seen that the capacitance per unit length (C′) has been reduced by a factor of five whilst the inductance per unit length (L′) remains unchanged. As a consequence the characteristic impedance of the transmission line has been increased from 22 Ω to 49 Ω, a figure very close to the 50 Ω desired for impedance matching to other devices. Impedance matching is required to avoid unwanted reflections, which not only reduce the available microwave power but can also interfere with the accurate encoding of information onto the optical ream and also lead to timing jitter.

TABLE 1

| Type of TW-EAM | Conventional | | New | |
|---|---|---|---|---|
| Optical waveguide width | 1.5 | μm | 1.5 | μm |
| Transmission line width | 6 | μm | 6 | μm |
| lnGaAs MQW layer thickness | 0.35 | μm | 0.35 | μm |
| Optical waveguide length | 200 | μm | 1000 | μm |
| Total EA length | 200 | μm | 200 | μm |
| Inductance L′ | 0.37 | nH/mm | 0.37 | nH/mm |
| Intrinsic capacitance C′ₜ | 0.54 | pF/mm | 0.108 | pF/mm |
| Stray capacitance C′ₛ | 0.23 | pF/mm | 0.046 | pF/mm |
| $Line impedance Z = \sqrt{{L}^{′} / ( {C}_{1}^{′} + {C}_{s}^{′} )}$ | 22 | Ω | 49 | Ω |

Another advantageous feature of the present invention is that the length of the transmission line sections electrically isolated from the waveguide can be adjusted by changing the dimensions and shape of the insulating material. This allows fine tuning of the relative distances travelled by the optical and microwave signals, and therefore effective velocity matching of the two signals to maximize the travelling wave effect.

The combination of features described in the present invention permits the full potential of a TW-EAM to be realized, with accurate impedance matching, high extinction ratio and wide bandwidth operation, in excess of 50 GHz.

1. A travelling-wave electroabsorption modulator (TW-EAM) comprising:
an optical waveguide with a plurality of adjacent regions electrically isolated from each other, the regions being characterized alternately by the properties of electroabsorption (EA) and optical transparency over a predetermined range of optical wavelengths; and,
a microwave transmission line located above the optical waveguide, sections of the transmission line located above EA regions in the optical waveguide being in electrical contact with said EA regions and sections of the transmission line located above transparent regions in the optical waveguide being electrically isolated from said transparent regions.

2. A TW-EAM according to claim 1, in which the EA regions are substantially absorbing when a microwave signal is applied to the microwave transmission line and substantially optically transparent in the absence of an applied microwave signal.

3. A TW-EAM according to claim 1 or 2, in which each of the EA regions are electrically isolated from each of the adjacent transparent regions.

4. A TW-EAM according to claim 3, in which an ea region is electrically isolated from an adjacent transparent region by etching the waveguide an interface between the ea region and the transparent region.

5. A TW-EAM according to claim 3 or 4, in which an EA region is electrically isolated from an adjacent transparent region by ion implantation.

6 A TW-EAM according to any of claims 3 to 5, in which an EA region is electrically isolated from an adjacent transparent region by doping.

7. A TW-EAM according to any preceding claim, in which the characteristic impedance of the microwave transmission line has a predetermined value dependent on the total length of sections of the transmission line located above the transparent regions in the optical waveguide.

8. A TW-EAM according to any preceding claim, in which the characteristic impedance of the microwave transmission line is 50 Ω.

9. A TW-EAM according to any preceding claim, in which the optical waveguide and the transmission line are substantially velocity matches so that, in use, the time taken by an optical signal to propagate along the length of the optical waveguide is substantially the same as the time taken by a microwave signal to propagate along the length of the transmission line.

10. A TW-EAM according to claim 9, in which the velocity matching is achieved in dependence on the relative lengths of the optical waveguide and the microwave transmission line.

11. A TW-EAM according to any of claims 3 to 10, in which the transmission line is electrically isolated from transparent regions in the optical waveguide by means of raised insulating regions.

12. A TW-EAM according to claim 11, in which local velocity matching is achieved in dependence on the length of each section of the transmission line over each of the raised insulating regions.

13. A TW-EAM according to any preceding claim, in which a portion of the optical waveguide comprises a multiple quantum well structure.

14. A TW-EAM according to claim 13, in which a multiple quantum well structure proximate an EA section of the optical waveguide is bandgap engineered to modify the electroabsorption characteristics of said section over the predetermined range of optical wavelengths.

15. A TW-EAM according to claim 13, in which a multiple quantum well structure proximate a transparent section of the optical waveguide is bandgap engineered to modify the transparency of said section over the predetermined range of optical wavelengths.

16. A TW-EAM according to claim 14 or 15, in which a multiple quantum well structure is bandgap engineered by a quantum well intermixing process.

17. A TW-EAM according to any preceding claim, in which an input portion and an output portion of the optical waveguide are substantially transparent.

18. A TW-EAM according to any preceding claim, fabricated on a substrate comprising an indium phosphide (InP) based material.

19. An optical device for optical time division multiplexing or demultiplexing, comprising a TW-EAM according to any preceding claim.
